(19) United States
(12) Patent Application Publication
(10) Pub. No.: US 2026/0075401 A1
(43) Pub. Date: Mar. 12, 2026

(54) SIDELINK COMMUNICATION METHOD AND TERMINAL DEVICE

(71) Applicant: GUANGDONG OPPO MOBILE TELECOMMUNICATIONS CORP., LTD., Dongguan (CN)

(72) Inventors: Yang LIU, Dongguan (CN); Xinlei YU, Dongguan (CN)

(21) Appl. No.: 19/395,048

(22) Filed: Nov. 20, 2025

Related U.S. Application Data
(63) Continuation of application No. PCT/CN2023/112696, filed on Aug. 11, 2023.

(51) Int. Cl. H04W 8/00; H04W 28/02

(52) U.S. Cl. CPC H04W 8/005; H04W 28/0268

(57) ABSTRACT

A sidelink communication method includes: transmitting, by a first terminal, a first discovery message, where the first discovery message comprises first information, wherein the first information is associated with one or more of: positioning quality of service (QoS), or a positioning method.

### CROSS-REFERENCE TO RELATED APPLICATION

This application is a Continuation Application of International Application No. PCT/CN2023/112696 filed on Aug. 11, 2023, which is incorporated herein by reference in its entirety.

### TECHNICAL FIELD

The present disclosure relates to the field of communication technology, and to a sidelink communication method and a terminal device.

### RELATED ART

In traditional ranging/sidelink positioning schemes, a target terminal device to be positioned may discover or select an anchor terminal device and a sidelink positioning server terminal device through a discovery procedure. Then, the target terminal device may perform positioning the target terminal device based on the discovered or selected anchor terminal device and the sidelink positioning server terminal device. However, a method for discovering and selecting an appropriate sidelink positioning server terminal device remains undefined.

### SUMMARY

The present disclosure provides a sidelink communication method and a terminal device. Various aspects of the present disclosure are described below.

In a first aspect, a sidelink communication method is provided, including: transmitting, by a first terminal device, a first discovery message, where the first discovery message includes first information, where the first information is associated with one or more of: positioning quality of service (QoS); or a positioning method.

In a second aspect, a sidelink communication method is provided, including: receiving, by a second terminal device, a first discovery message, where the first discovery message includes first information, where the first information is associated with one or more of: positioning QoS; or a positioning method.

In a third aspect, a terminal device is provided, where the terminal device is a first terminal device and includes: a communication unit, configured to transmit a first discovery message, where the first discovery message includes first information, where the first information is associated with one or more of: positioning QoS, or a positioning method.

In a fourth aspect, a terminal device is provided, where the terminal device is a second terminal device and includes: a communication unit, configured to receive a first discovery message, where the first discovery message includes first information, where the first information is associated with one or more of: positioning QoS, or a positioning method.

In a fifth aspect, a terminal device is provided, including a transceiver, a memory and a processor, where the memory is configured to store a program, and the processor is configured to invoke the program from the memory and control the transceiver to receive or transmit signals, to enable the terminal to perform the method according to any one of the first aspect or the second aspect.

In a sixth aspect, an apparatus is provided, including a processor, configured to invoke a program from a memory, to enable the apparatus to perform the method according to any one of the first aspect or the second aspect.

In a seventh aspect, a chip is provided, including a processor, configured to invoke a program from a memory, to enable a device equipped with the chip to perform the method according to any one of the first aspect or the second aspect.

In an eighth aspect, a non-transitory computer-readable storage medium is provided, having stored thereon a program, where the program enables a computer to perform the method according to any one of the first aspect or the second aspect.

In a ninth aspect, a computer program product is provided, including a program, where the program enables a computer to perform the method according to any one of the first aspect or the second aspect.

In a tenth aspect, a computer program is provided, where the computer program enables a computer to perform the method according to any one of the first aspect or the second aspect.

### BRIEF DESCRIPTION OF THE DRAWINGS

FIG. 1 is a system architecture diagram of a wireless communication system to which an embodiment of the present disclosure may be applied.

FIG. 2 is a schematic diagram of a ranging/sidelink positioning process.

FIG. 3 is a schematic diagram of a discovery procedure of model A.

FIG. 4 is a schematic diagram of a discovery procedure of model B.

FIG. 5 is a flowchart of a sidelink communication method according to an embodiment of the present disclosure.

FIG. 6 is a flowchart of a possible implementation of the method illustrated in FIG. 5.

FIG. 7 is a flowchart of another possible implementation of the method illustrated in FIG. 5.

FIG. 8 is a flowchart of another possible implementation of the method illustrated in FIG. 5.

FIG. 9 is a flowchart of another possible implementation of the method illustrated in FIG. 5.

FIG. 10 is a flowchart of another possible implementation of the method illustrated in FIG. 5.

FIG. 11 is a flowchart of another possible implementation of the method illustrated in FIG. 5.

FIG. 12 is a schematic structural diagram of a terminal device provided in an embodiment of the present disclosure.

FIG. 13 is a schematic structural diagram of a terminal device provided in another embodiment of the present disclosure.

FIG. 14 is a schematic structural diagram of an apparatus according to an embodiment of the present disclosure.

### DETAILED DESCRIPTION

To facilitate understanding of the present disclosure, the following first introduces the communication system and communication process applicable to the embodiments of the present disclosure in conjunction with the accompanying drawings.

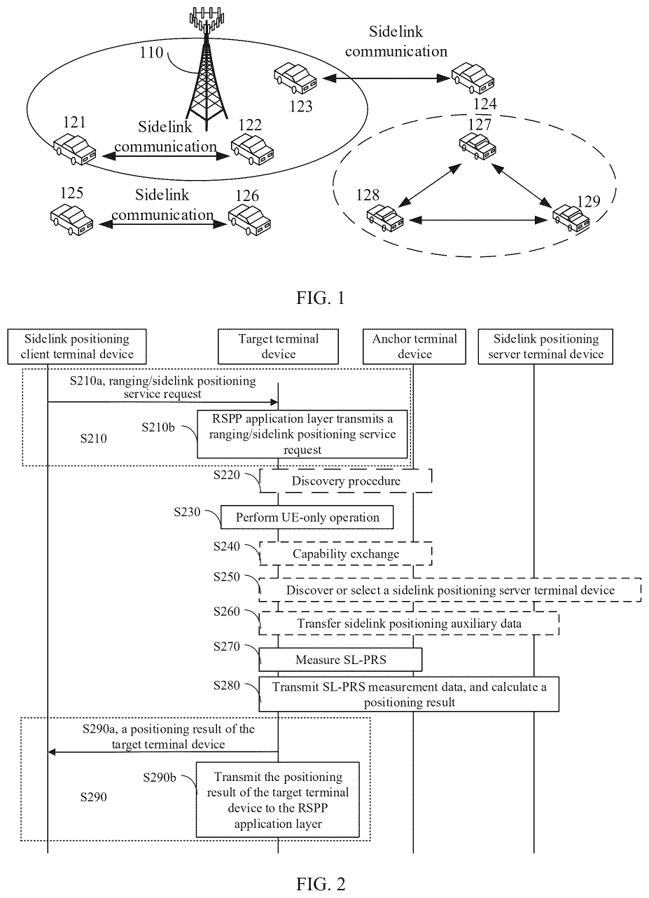

FIG. 1 illustrates a wireless communication system 100 to which embodiments of the present disclosure may be applied. The wireless communication system 100 may include a network device 110 and terminal devices 121 to 129. The network device 110 may provide communication coverage for a specific geographical area and may communicate with terminal devices located within the coverage area.

In some implementations, terminal devices may communicate with each other via a sidelink (SL). Sidelink communication may also be called as proximity services (ProSe) communication, unilateral communication, sidechain communication, or device to device (D2D) communication.

In other words, sidelink data is transmitted between terminal devices via the sidelink. The sidelink data may include data and/or control signaling. In some implementations, the sidelink data may be, for example, a physical sidelink control channel (PSCCH), a physical sidelink shared channel (PSSCH), a PSCCH demodulation reference signal (DMRS), a PSSCH DMRS, a physical sidelink feedback channel (PSFCH), etc.

The following describes several common sidelink communication scenarios with reference to FIG. 1. In sidelink communications, four scenarios may be classified according to whether the terminal devices in the sidelink are within the coverage of a network device. In a scenario 1, the terminal device performs sidelink communication within the coverage of the network device. In a scenario 2, some terminal devices perform sidelink communication within the coverage of the network device. In a scenario 3: the terminal device performing sidelink communication outside the coverage of the network device.

As illustrated in FIG. 1, in the scenario 1, terminal devices 121 and 122 may communicate through a sidelink, and the terminal devices 121 and 122 are all within the coverage of a network device 110, or in other words, the terminal devices 121 and 122 are all within the coverage of the same network device 110. In this scenario, the network device 110 may send configuration signaling to the terminals 121 and 122, and accordingly, the terminals 121 and 122 communicate via the sidelink based on the configuration signaling.

As illustrated in FIG. 1, in the scenario 2, terminal devices 123 and 124 may communicate via a sidelink, and the terminal device 123 is within the coverage of the network device 110, while the terminal device 124 is outside the coverage of the network device 110. In this scenario, the terminal device 123 receives configuration information from the network device 110 and communicates via the sidelink based on the configuration of the configuration signaling. However, for the terminal device 124, since the terminal device 124 is outside a coverage range of the network device 110, it may not receive the configuration information of the network device 110. At this time, the terminal device 124 may obtain the configuration of the sidelink communication based on the pre-configured configuration information and/or the configuration information transmitted from the terminal device 123 within the coverage range, so as to communicate with the terminal device 123 through the sidelink based on the obtained configuration.

In some cases, the terminal device 123 may transmit the above configuration information to the terminal device 124 via the sidelink broadcast channel physical sidelink broadcast channel (PSBCH) to configure the terminal device 124 to communicate via the sidelink.

As illustrated in FIG. 1, in the scenario 3, terminal devices 125 to 129 are all outside the coverage of the network device 110 and are unable to communicate with the network device 110. In this case, the terminal devices may configure sidelink communications based on pre-configured information.

In some cases, the terminal devices 127 to 129 that are outside the coverage of the network device may form a communication group, and the terminal devices 127 to 129 in the communication group may communicate with each other. In addition, the terminal device 127 in the communication group may serve as a central control node, also known as a cluster header (CH), and correspondingly, the terminal devices in other communication groups may be referred to as “group members”.

The terminal device 127 as a CH may have one or more of the following functions: responsible for establishing a communication group, joining and leaving of group members, coordinating resources, allocating sidelink transmission resources to group members, receiving sidelink feedback information from group members, or coordinating resources with other communication groups, etc.

It should be noted that FIG. 1 exemplarily illustrates a network device and multiple terminal devices. Optionally, the wireless communication system 100 may include multiple network devices and the respective coverage range of each network device may include other numbers of terminal devices, which is not limited in the embodiment of the present disclosure.

Optionally, the wireless communication system 100 may further include other network entities such as a network controller and a mobility management entity, which is not limited in the embodiment of the present disclosure.

It should be understood that the technical schemes of the embodiments of the present disclosure may be applied to various communication systems, such as: a fifth generation (5G) system or a new radio (NR), a long term evolution (LTE) system, an LTE frequency division duplex (FDD) system, an LTE time division duplex (TDD) system, etc. The technical scheme provided in this disclosure may also be applied to future communication systems, such as the sixth-generation mobile communication system, satellite communication system, etc.

The terminal device in the embodiments of the present disclosure may also be referred to as user equipment (UE), a access terminal, a user unit, a user station, a mobile platform, a mobile station (MS), a mobile terminal (MT), a remote station, a remote terminal, a mobile device, a user terminal, a terminal, a wireless communication device, a user agent or a user apparatus. The terminal device in the embodiments of the present disclosure may refer to a device that provides voice and/or data connectivity to users and may be used to connect people, objects and machines, such as a handheld device or a vehicle-mounted device with a wireless connection function. The terminal device in the embodiments of the present disclosure may be a mobile phone, a pad, a laptop computer, a personal digital assistant, a mobile internet device (MID), a wearable device, a virtual reality (VR) device, an augmented reality (AR) device, a wireless terminal in industrial control, a wireless terminal in self driving, a wireless terminal in remote medical surgery, a wireless terminal in a smart grid, a wireless terminal in transportation safety, a wireless terminal in a smart city, a wireless terminal in a smart home, or the like. Optionally, the terminal device may be used to act as a base station. For example, the terminal device may act as a scheduling entity that provides sidelink signals between terminal devices in V2X or D2D or the like. For example, a cellular phone and a car communicate with each other using sidelink signals. The cellular phone and a smart home device communicate with each other without relaying communication signals through a base station.

The network device in the embodiments of the present disclosure may be a device that is used to communicate with the terminal device, and the network device may also be referred to as an access network device or a wireless access network device, for example, the network device may be a base station. The network device in the embodiments of the present disclosure may refer to a radio access network (RAN) node (or device) that connects the terminal device to the wireless network. The base station may broadly cover various names among, or be replaced with, the following names, such as: a NodeB, an evolved NodeB (eNB), a next generation NodeB (gNB), a relay station, an access point, a transmitting and receiving point (TRP), a transmitting point (TP), a master eNB (MeNB), a secondary eNB (SeNB), a multi-standard radio (MSR) node, a home base station, a network controller, an access node, a wireless node, an access point (AP), a transmission node, a transceiver node, a base band unit (BBU), a remote radio unit (RRU), an active antenna unit (AAU), a remote radio head (RRH), a central unit (CU), a distributed unit (DU), or a positioning node. The base station may be a macro base station, a micro base station, a relay node, a donor node or analogues, or a combination thereof. The base station may also refer to a communication module, modem or chip configured in the aforementioned device or apparatus. The base station may also be a mobile switching center, a device that performs base station functions in device-to-device (D2D), vehicle-to-everything (V2X), and machine-to-machine (M2M) communications, a network-side device in a 6G network, or a device that performs base station functions in future communication systems. The base station may support networks of the same or different access technologies. The embodiments of the present disclosure do not limit the specific technology and specific device form adopted by the network device.

The base station may be fixed or mobile. For example, a helicopter or drone may be configured to act as a mobile base station, and one or more cells may move based on the location of the mobile base station. In other examples, a helicopter or drone may be configured to function as a device communicating with another base station.

In some deployments, the network device in the embodiments of the present disclosure may refer to a CU or a DU, or the network device includes the CU and the DU. The gNB may also include an AAU.

The network device and the terminal device may be deployed on land, including indoors or outdoors, handheld or vehicle-mounted; they may also be deployed on water surfaces; and they may also be deployed in the air on aircraft, balloons and satellites. The embodiments of the present disclosure do not limit the scenarios in which the network device and terminal device are located.

It should be understood that all or part of the functions of the communication device in this disclosure may also be implemented through software functions running on hardware, or through virtualization functions instantiated on a platform (such as a cloud platform).

### Sidelink-Based Positioning

Some protocols (e.g., in 3GPP R-17) have studied positioning based on sidelinks. For example, studies were conducted on “NR positioning enhancement” and “scenarios and requirements for NR positioning use cases in-coverage, partial coverage and out-of-coverage”. Among them, the study on “scenarios and requirements for NR positioning use cases in-coverage, partial coverage and out-of-coverage” focused on V2X and public safety use cases. In addition, some organizations (such as the 3GPP SAI working group) have also developed requirements for “ranging-based services” and have established positioning accuracy requirements for IoT use cases in out-of-coverage scenarios. 3GPP needs to research and develop sidelink-based positioning schemes to support the use cases, scenarios and requirements identified in these activities.

To improve positioning accuracy, particularly for positioning of UEs located outside cellular network coverage, 3GPP completed feasibility and performance research of positioning technology based on a sidelink positioning reference signal in the early stage of R18. Then the scheme based on sidelink positioning (including ranging/direction finding) in NR systems will be standardized. The scheme based on sidelink positioning mainly includes the following aspects of standardization work.

Standardization item 1: standardization of the sidelink positioning reference signal (SL PRS). SL PRS may use a frequency domain structure based on a comb pattern (not excluding the full RE mapping mode) and a sequence format based on a pseudo-random sequence. The design of SL PRS may take the existing downlink positioning reference signal (DL-PRS) sequence as a starting point, supporting a maximum SL PRS bandwidth of 100 MHz in FR1.

Standardization item 2: standardization of measurements for sidelink positioning. For example, standardization is used to support measurements of SL round trip time (RTT), SL angle of arrival (AOA), and SL time difference of arrival (TDOA) positioning methods.

Standardization item 3: standardization of resource allocation schemes of SL PRS. For example, the SL PRS resource allocation schemes include a resource allocation scheme 1 and a resource allocation scheme 2, where the scheme 1 corresponds to the network allocating SL PRS resources, and the scheme 2 corresponds to the UE autonomously selecting SL PRS resources. In some implementations, the system supports both an SL PRS resource pool shared with Rel-16/17/18 sidelink communication and a dedicated SL PRS resource pool. In some implementations, for the scheme 2, one or more of the following needs to be studied and standardized: resource selection based on channel sensing, random resource selection, congestion control, or resource selection based on UE coordination.

Standardization item 4: standardization of an open-loop power control mechanism for SL PRS transmission.

### Out-of-Coverage Sidelink-Based Positioning

Some protocols (for example, 3GPP TS 23.586) provide a ranging/sidelink positioning scheme outside the network coverage range, which is applicable to the ranging/sidelink positioning scenario when the terminal device is not within the network coverage range. In such a scenario, ranging/sidelink positioning of the terminal device may be performed through the PC5 interface. Ranging refers to determining the distance between two or more terminal devices and/or the direction of one terminal device to another terminal device. Sidelink-based positioning refers to obtaining an absolute location or a relative location of the terminal device based on the sidelink.

In the sidelink positioning scheme, based on different roles, terminal devices may be classified into a sidelink positioning client terminal device, a target terminal device, a sidelink reference terminal device and a sidelink positioning server terminal device.

The target terminal device may also be referred to as a target UE. The target terminal device generally refers to the terminal device to be positioned.

The sidelink positioning client terminal device may also be referred to as a sidelink positioning client UE (SL positioning client UE). The sidelink positioning client terminal device may be used to transmit a ranging/sidelink positioning service request to the target terminal device.

The sidelink reference terminal device may also be referred to as a sidelink positioned terminal device, a sidelink positioned UE (SL located UE), an anchor terminal device, or an anchor UE. Generally speaking, the location of the sidelink reference terminal device is known. The location of the sidelink reference terminal device may be used as reference information for positioning the target terminal device.

The sidelink positioning server terminal device may also be referred to as a sidelink positioning server UE (SL positioning server UE). The sidelink positioning server terminal device may be configured to provide functions such as auxiliary data distribution and/or location calculation in the sidelink positioning of the target terminal device. It should be understood that the target terminal device or the sidelink reference positioning terminal device may also serve as the sidelink positioning server terminal device.

Two terminal devices among the sidelink positioning client terminal device, the target terminal device, the sidelink reference terminal device or the sidelink positioning server terminal device may communicate through the PC5 interface.

The ranging/sidelink positioning scheme outside the network coverage range may be understood as a ranging/sidelink positioning scheme for UE-only operation. That is, in this scheme, the processing of service request and the calculation of result are all performed by the terminal device without any involvement of the network device. For ease of understanding, the following describes the positioning process applicable to the embodiment of the present disclosure in conjunction with FIG. 2. As illustrated in FIG. 2, the scheme includes operations S210 to S290.

In an operation S210, the target terminal device receives a ranging/sidelink positioning service request. The service request may be used to request performing ranging or sidelink positioning on the target terminal device.

For example, the service request may be a service request transmitted from the sidelink positioning client terminal device to the target terminal device (see an operation S210a in FIG. 2), in a case where the sidelink positioning client terminal device expects to obtain an absolute location of the target terminal device, the service request may include one or more of: user information of the sidelink positioning client terminal device, user information of the target terminal device, or required positioning quality of service (QoS). In a case where the sidelink positioning client terminal device expects to obtain a relative location of the target terminal device, the service request may include one or more of: the user information of the sidelink positioning client terminal device, the user information of the target terminal device, user information of the sidelink reference terminal device, or the required positioning quality of service, etc.

For another example, the service request may also be a service request transmitted from a sidelink positioning protocol/ranging and sidelink positioning protocol (SLPP/RSPP) application layer of the target terminal device (see an operation S210b in FIG. 2). In some implementations, the service request may include one or more of: a type of positioning result (e.g., absolute position, relative position, or ranging information) or the required QoS.

In an operation S220, the target terminal device discovers other terminal devices through a discovery procedure. The other terminal devices mentioned here may include, for example, an anchor terminal device and/or a sidelink positioning server terminal device.

In an operation S230, in a case where there is no terminal device served by a wireless access network within the network coverage, or a serving network does not support ranging/sidelink positioning, the target terminal device performs the UE-only operation.

In an operation S240, capability interaction is performed between the target terminal device and the other terminal devices.

In an operation S250, in a case where the target terminal device does not support sidelink positioning server functionalities and no sidelink positioning server terminal device is discovered in the operation S220, the target terminal device discovers the sidelink positioning server terminal device and requires the sidelink positioning server terminal device to participate in ranging/sidelink positioning.

In an operation S260, sidelink positioning auxiliary data is transmitted among the target terminal device, the anchor terminal device, and the sidelink positioning server terminal device.

It should be noted that the above operation S240 may also be performed before the operations S250 and S260, and may be coordinated by the sidelink positioning server terminal device.

In an operation S270, the target terminal device and the anchor terminal device measure the SL-PRS.

For example, the target terminal device and the anchor terminal device may measure the SL-PRS between the target terminal device and the anchor terminal device. Optionally, the anchor terminal device may also measure the SL-PRS transmitted among the respective anchor terminal devices.

In an operation S280, the target terminal device and the anchor terminal device transmit measurement data of the SL-PRS to the sidelink positioning server terminal device, and the sidelink positioning server terminal device calculates a positioning result based on the measurement data.

It should be noted that, in a case where the target terminal device supports the sidelink positioning server functionalities, the measurement data of the SL-PRS may also be transmitted to the target terminal device. Accordingly, the sidelink positioning server terminal device or the target terminal device may calculate, based on the measurement data of the SL-PRS, an absolute position, a relative location or ranging information of the target terminal device according to the result type received in the operation S210.

In the operation S290a, in a case where the ranging/sidelink positioning service request is transmitted from the sidelink positioning client terminal device, the target terminal device transmits the positioning result of the target terminal device to the sidelink positioning client terminal device.

In the operation S290b, in a case where the ranging/sidelink positioning service request is transmitted from the RSPP application layer, the target terminal device transmits the positioning result of the target terminal device to the RSPP application layer.

### Positioning QoS

The QoS of the location service (LCS) (also known as “positioning QoS”) is specified in some protocols (e.g., TS 23.273) to describe the characteristics of a positioning request. It may be determined by the operator or through negotiation with the LCS client or application function (AF). It should be understood that the LCS QoS provided by the LCS client or AF in the location request is optional.

In some implementations, the characteristics of the LCS QoS information may include three key attributes which are described respectively below.

The first attribute is LCS QoS class. The LCS QoS class defines that in a case where another QoS parameter (such as accuracy) has requirements, the LCS QoS class is used to define the degree to which the LCS service complies with another QoS parameter. Currently, there are three main LCS QoS classes: a best effort class, a multiple QoS class, and an assured class.

The second attribute is accuracy, such as horizontal accuracy as specified in clause 4.3.1 of TS 22.071, or vertical accuracy as specified in clause 4.3.2 of TS 22.071.

The third attribute is response delay (or referred to as response time), which refers to the maximum tolerated time between the reception time of the LCS request and the transmission time of the LCS response including the positioning result. The response delay may be, for example, no delay, low delay, or delay tolerant in clause 4.3.3 of TS 22.071.

### Positioning Method

Existing positioning methods include an enhanced cell ID based positioning method, a round-trip time based (RTT based) positioning method, a time difference of arrival based (TDOA based) positioning method, and an angle-of-arrival based (AOA based) positioning method.

Different positioning methods may be able to meet different positioning QoS. In other words, different positioning methods may be associated with different positioning QoS. In some implementations, different positioning methods may meet different positioning accuracies. For example, the enhanced cell ID based positioning method has the lowest positioning accuracy, the angle-of-arrival based positioning method has the second lowest positioning accuracy, the time difference of arrival based positioning method has medium positioning accuracy, and the round-trip time based positioning method has the highest positioning accuracy. In other words, the positioning accuracy of enhanced cell ID based positioning method is lower than that of the angle-of-arrival based positioning method, the positioning accuracy of the angle-of-arrival based positioning method is lower than that of the time difference of arrival based positioning method, and the positioning accuracy of the time difference of arrival based positioning method is lower than that of the round-trip time based positioning method.

In other implementations, different positioning methods require different processing times, which may result in different positioning methods being able to satisfy different response time requirements. For example, since the round-trip time based positioning method requires two transmissions of the reference signal, the response time corresponding to the round-trip time based positioning method is longer than the response time corresponding to other positioning methods.

### Provide Capabilities Information

In some implementations, the target terminal device may indicate the LPP capability of the target terminal device by the provide capability information (also referred to as “capability information”) in an LPP message.

For ease of understanding, a capability information code is shown below. Referring to the capability information code, the capability information includes information elements (IE) that may include one or more of: common IE capabilities (expressed as “commonIEsProvideCapabilities”); assisting-global navigation satellite system (A-GNSS) capability information (expressed as “a-gnss-ProvideCapabilities”); observed time difference of arrival (OTDOA) capability information (expressed as “otdoa-ProvideCapabilities”); enhanced positioning technology based on Cell ID (enhanced Cell-ID, E-CID) capability information (expressed as “ecid-ProvideCapabilities”); enhanced protocol data unit (E-PDU) capability information (expressed as “epdu-ProvideCapabilities”); sensor capability information (expressed as “sensor-ProvideCapabilities”); transport block size (TBS) capability information (expressed as “tbs-ProvideCapabilities”); wireless local network (WLAN) capability information (expressed as “wlan-ProvideCapabilities”); bluetooth (BT) capability information (expressed as “bt-ProvideCapabilities”); new radio enhanced Cell-ID (NR-ECID) capability information (expressed as “nr-ECID-ProvideCapabilities”); new radio multiple round-trip-time (NR-Multi-RTT) capability information (expressed as “nr-Multi-RTT-ProvideCapabilities”); NR downlink angle-of-departure (NR-DL-AoD) capability information (expressed as “nr-DL-AoD-ProvideCapabilities”); new radio downlink time difference of arrival (NR-DL-TDOA) capability information (expressed as “nr-DL-TDOA-ProvideCapabilities”); new radio uplink (NR-UL) capability information (expressed as “nr-UL-ProvideCapabilities”).

--ASN1START
ProvideCapabilities ::= SEQUENCE {

| criticalExtensions | | CHOICE { | |
|---|---|---|---|
| | c1 | | CHOICE { |

| | |
|---|---|
| provideCapabilities-r9 | ProvideCapabilities-r9-IEs, |

spare3 NULL, spare2 NULL, spare1 NULL
},
criticalExtensionsFuture SEQUENCE { }

}
}
ProvideCapabilities-r9-IEs ::= SEQUENCE {

| | |
|---|---|
| commonIEsProvideCapabilities | CommonIEsProvideCapabilities |

OPTIONAL,

| | |
|---|---|
| a-gnss-ProvideCapabilities | A-GNSS-ProvideCapabilities |

OPTIONAL,

| | |
|---|---|
| otdoa-ProvideCapabilities | OTDOA-ProvideCapabilities |

OPTIONAL,

| | |
|---|---|
| ecid-ProvideCapabilities | ECID-ProvideCapabilities OPTIONAL, |
| epdu-ProvideCapabilities | EPDU-Sequence |

OPTIONAL,
...,

| | | |
|---|---|---|
| [[ | sensor-ProvideCapabilities-r13 | Sensor-ProvideCapabilities-r13 |

OPTIONAL,

| | |
|---|---|
| tbs-ProvideCapabilities-r13 | TBS-ProvideCapabilities-r13 |

OPTIONAL,

| | |
|---|---|
| wlan-ProvideCapabilities-r13 | WLAN-ProvideCapabilities-r13 |

OPTIONAL,

| | |
|---|---|
| bt-ProvideCapabilities-r13 | BT-ProvideCapabilities-r13 |

```
  OPTIONAL
  ]],
```

| | | |
|---|---|---|
| [[ | nr-ECID-ProvideCapabilities-r16 | NR-ECID-ProvideCapabilities-r16 |

OPTIONAL,

nr-Multi-RTT-ProvideCapabilities-r16

NR-Multi-RTT-ProvideCapabilities-r16
OPTIONAL,

nr-DL-AoD-ProvideCapabilities-r16

NR-DL-AoD-ProvideCapabilities-r16

OPTIONAL,

nr-DL-TDOA-ProvideCapabilities-r16

NR-DL-TDOA-ProvideCapabilities-r16

OPTIONAL,

| | |
|---|---|
| nr-UL-ProvideCapabilities-r16 | NR-UL-ProvideCapabilities-r16 |

```
  OPTIONAL
  ]]
}
--ASN1STOP
```

### Discovery Procedure

Currently, the discovery procedure is classified into two models: model A and model B.

Model A defines two roles for prose-enabled terminal devices (prose-enabled UEs) participating in prose direct discovery: announcing terminal device (announcing UE) and monitoring terminal device (monitoring UE). The announcing UE may use an announcement message (also called a “discovery announcement message”) to announce information related to the announcing UE, and this information may be used by neighbouring UEs with discovery permission. The monitoring UE may monitor certain interesting information transmitted from the nearby announcing UE. The monitoring UE has discovery authority and may discover the announcing UE that meets its requirements.

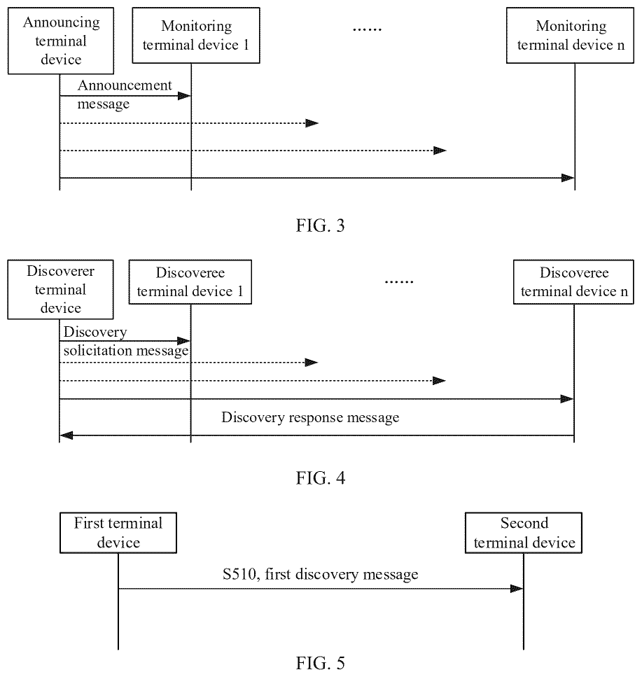

The discovery procedure of model A is illustrated in FIG. 3. The announcing UE may broadcast announcement messages at predefined discovery intervals. Accordingly, the monitoring UE interested in the announcement messages can read and process these messages. This mode may be understood as the announcing UE transmitting “I am here” in a broadcast manner. For example, the announcement message may include a prose application code.

Model B defines two roles for the prose-enabled UE participating in prose direct discovery when using a restricted discovery type: discoverer terminal device (discoverer UE) and discoveree terminal device (discoveree UE). The discoverer UE may transmit a solicitation message (also called a “discovery solicitation message”) containing certain information that the discoverer UE is interested in discovering, thereby discovering a discoveree terminal that meets its needs. The discoveree UE may receive a solicitation message and respond with some information related to the requirements in the solicitation message through a response message (also called a “discovery response message”).

The discovery procedure of model B is illustrated in FIG. 4, which is equivalent to the discoverer UE transmitting “Who is there/Are you there” through the discovery solicitation message. That is, the discoverer UE may transmit information about other terminal devices that hope to receive a response through the discoverer UE. For example, the information may be the prose application identity corresponding to a group, and the members of the group may respond.

In the above-mentioned ranging/sidelink positioning scheme, the target terminal device may discover or select the anchor terminal device and the sidelink positioning server terminal device by performing the discovery procedure, and position the target terminal device based on the discovered or selected anchor terminal device and the sidelink positioning server terminal device. However, how to discover and select a suitable sidelink positioning server terminal device is still unclear.

In the ranging/sidelink positioning scheme illustrated in FIG. 2, the target terminal device to be positioned needs to discover or select the sidelink positioning server terminal device. However, how to discover and select a suitable sidelink positioning server terminal device has not yet been clarified.

In response to the above problems, the embodiments of the present disclosure are described in detail.

It can be seen from the positioning process described in FIG. 2 above that the ranging/sidelink positioning service request received by the target terminal device carries positioning QoS information (or positioning QoS requirement), and thus the positioning method that may meet the positioning QoS information may be determined. Therefore, before finally selecting the sidelink positioning server terminal device, only the target terminal device may obtain the positioning QoS information. Taking this into consideration, the embodiment of the present disclosure chooses to carry information related to the positioning QoS and/or the positioning method in the discovery message related to the discovery procedure of the anchor terminal device and/or the discovery message related to the discovery procedure of the sidelink positioning server terminal device, so as to select a suitable sidelink positioning server terminal device. The embodiment of the present disclosure is described in detail below with reference to FIG. 5.

FIG. 5 is a schematic flowchart of the sidelink communication method provided by an embodiment of the present disclosure. The method of FIG. 5 may be performed by the first terminal device and the second terminal device.

In some embodiments, the first terminal device is the target terminal device, that is, a terminal device to be positioned. Accordingly, the second terminal device may be the anchor terminal device or the sidelink positioning server terminal device.

In some embodiments, the first terminal device is the anchor terminal device or the sidelink positioning server terminal device. Correspondingly, the second terminal device may be the target terminal device.

Referring to FIG. 5, in an operation S510, the first terminal device transmits the first discovery message. Correspondingly, the second terminal device receives the first discovery message. The first discovery message may include first information, where the first information is associated with one or more of: positioning QoS (or positioning QoS requirement) or the positioning method.

In some embodiments, the first information may be used to discover or select the sidelink positioning server terminal device.

In some embodiments, the first discovery message is a discovery message transmitted during the discovery or selection procedure of the anchor terminal device.

In some embodiments, the first discovery message is a discovery message transmitted during a discovery or selection procedure of the sidelink positioning server terminal device.

In some embodiments, the first discovery message may be a discovery announcement message. That is, the first information may be carried in the discovery announcement message.

In some embodiments, the first discovery message may be a discovery solicitation message. That is to say, the above-mentioned first information may be carried in the discovery solicitation message.

In some embodiments, the first discovery message may be a discovery response message. That is to say, the above-mentioned first information may be carried in the discovery response message.

For ease of understanding, the method illustrated in FIG. 5 is illustrated in more detail below in combination with the first embodiment, the second embodiment, and the third embodiment by taking the first discovery message as the discovery announcement message, the discovery solicitation message, and the discovery response message as examples respectively.

### The First Embodiment: The First Discovery Message is the Discovery Announcement Message

In the first embodiment, the first terminal device may be the anchor terminal device, and the second terminal device may be the target terminal device. The discovery procedure between the first terminal device and the second terminal device may be the discovery procedure based on model A.

In some implementations, the discovery announcement message may be used to discover the anchor terminal device.

In some implementations, the discovery announcement message may be used to discover the sidelink positioning server terminal device.

In some implementations, the first information may be used to indicate part or all of the positioning QoS information supported by the first terminal device.

In some implementations, the first information may be used to indicate the most affordable supported positioning QoS information of the first terminal device.

In some implementations, the positioning QoS information may include or be replaced by a positioning QoS requirement.

In some implementations, the first information may be used to indicate a positioning method supported by the first terminal device.

In some implementations, the first information may be used to indicate positioning QoS information supported by the first terminal device and/or positioning method supported by the first terminal device as the sidelink positioning server terminal device.

In some implementations, in a case where the first discovery message is used to discover the anchor terminal device, the first discovery message may further include information indicating that the anchor terminal device needs to be discovered or selected. This information may be called, for example, an anchor terminal device role indication, or an anchor UE role indication.

In some implementations, in a case where the first discovery message is used to discover the sidelink positioning server terminal device, the first discovery message may further include information indicating that the sidelink positioning server terminal device needs to be discovered or selected. This information may be called, for example, a sidelink positioning server terminal device role indication, or a sidelink positioning server UE role indication.

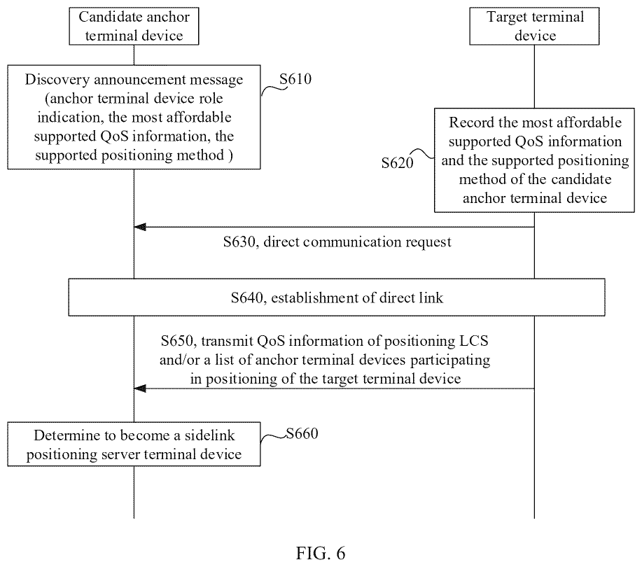

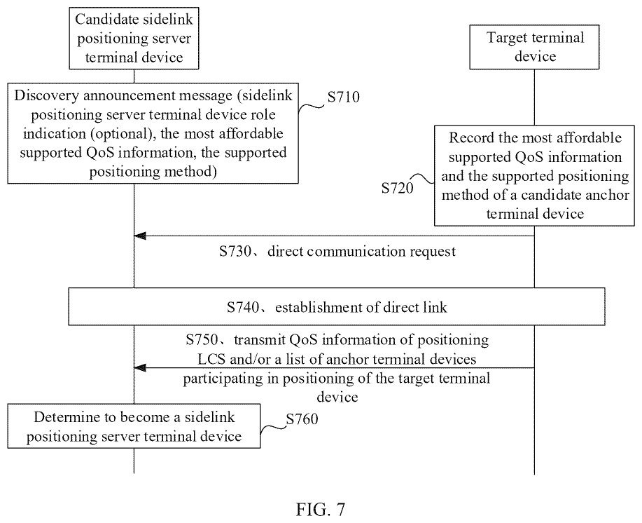

With reference to FIG. 6 and FIG. 7, two more examples of the first embodiment are provided below by taking the discovery procedure of the anchor terminal device and the sidelink positioning server terminal device as examples.

The example illustrated in FIG. 6 describes the discovery procedure of the anchor terminal device. In the example of FIG. 6, the first terminal device mentioned above is a candidate anchor terminal device, and the second terminal device mentioned above is the target terminal device.

Referring to FIG. 6, in an operation S610, the candidate anchor terminal device transmits a discovery announcement message. The discovery announcement message includes the anchor terminal device role indication, the most affordable supported QoS information of the candidate anchor terminal device, and the positioning method supported by the candidate anchor terminal device (or the positioning method supported by the candidate anchor terminal device as the sidelink positioning server terminal device).

In an operation S620, the target terminal device records the most affordable supported QoS information of the candidate anchor terminal device and the positioning method supported by the candidate anchor terminal device.

In an operation S630, the target terminal device transmits a direct communication request to the candidate anchor terminal device. The direct communication request may be used to request establishment of a direct link (or PC5 link) with the candidate anchor terminal device.

In an operation S640, the direct link is established between the target terminal device and the candidate anchor terminal device.

In an operation S650, the target terminal device uses the candidate anchor terminal device as the sidelink positioning server terminal device, and transmits the QoS information of the positioning LCS and/or the list of anchor terminal devices participating in the positioning of the target terminal device to the candidate anchor terminal device.

In an operation S660, the candidate anchor terminal device is determined to become the sidelink positioning server terminal device.

The example illustrated in FIG. 7 describes the discovery procedure of the sidelink positioning server terminal device. In the example of FIG. 7, the first terminal device mentioned above is the candidate sidelink positioning server terminal device, and the second terminal device mentioned above is the target terminal device.

Referring to FIG. 7, in an operation S710, the candidate sidelink positioning server terminal device transmits the discovery announcement message. The discovery announcement message includes the sidelink positioning server terminal device role indication (optional), the most affordable supported QoS information of the candidate sidelink positioning server terminal device, and the positioning method supported by the candidate sidelink positioning server terminal device.

In an operation S720, the target terminal device records the most affordable supported QoS information of the candidate sidelink positioning server terminal device and the positioning method supported by the candidate sidelink positioning server terminal device.

In an operation S730, the target terminal device transmits a direct communication request to the candidate sidelink positioning server terminal device. The direct communication request may be used to request establishment of the direct link (or PC5 link) with the candidate sidelink positioning server terminal device.

In an operation S740, the direct link is established between the target terminal device and the candidate sidelink positioning server terminal device.

In an operation S750, the target terminal device uses the candidate sidelink positioning server terminal device as the sidelink positioning server terminal device, and transmits QoS information of the positioning LCS and/or the list of anchor terminal devices participating in the positioning of the target terminal device to the candidate sidelink positioning server terminal device.

In an operation S770, the candidate sidelink positioning server terminal device is determined to become the sidelink positioning server terminal device.

### The Second Embodiment: The First Discovery Message is the Discovery Solicitation Message

In the second embodiment, the first terminal device may be the target terminal device, and the second terminal device may be the candidate anchor terminal device. The discovery procedure between the first terminal device and the second terminal device may be a discovery procedure based on model B.

In some implementations, the discovery solicitation message may be used to discover the anchor terminal device.

In some implementations, the discovery solicitation message may be used to discover the sidelink positioning server terminal device.

In some implementations, the first information may be used to indicate positioning QoS information required by the first terminal device. Alternatively, the first information may be used to indicate positioning QoS information required by the first terminal device as the sidelink positioning server terminal device.

In some implementations, the first information may be used to indicate the positioning method required by the first terminal device. Alternatively, the first information may be used to indicate the positioning method that the sidelink positioning server terminal device needs to adopt.

In some implementations, the discovery solicitation message may further include second information. The second information may be used to indicate that the sidelink positioning server terminal device needs to be discovered or selected.

In some implementations, the discovery solicitation message may further include information indicating that the anchor terminal device needs to be discovered or selected.

In some implementations, the first terminal device may receive the discovery response message transmitted from the second terminal device. The discovery response message may include third information. The third information may be used to indicate one or more of: the second terminal device supporting the positioning QoS information required by the first terminal device and/or a positioning method required by the first terminal device; or the second terminal device is capable of serving as a sidelink positioning server terminal device. The third information may be, for example, identification information (flag).

In some implementations, the third information may include a first bit (the first bit may include 1 bit or multiple bits). In a case where a value of the first bit is a first value, the first bit may be used to indicate that the second terminal device is capable of serving as the sidelink positioning server terminal device; and/or, in a case where the value of the first bit is a second value (different from the first value), the first bit may be used to indicate that the second terminal device is incapable of serving as the sidelink positioning server terminal device.

It should be noted that the embodiment of the present disclosure does not limit the transmission timing of the discovery response message. In some embodiments, in a case where the second terminal device is capable of serving as the anchor terminal device and/or the sidelink positioning servicer terminal device, the second terminal device may transmit the discovery response message. On the contrary, in a case where the second terminal device is incapable of serving as the anchor terminal device and/or the sidelink positioning servicer terminal device, the second terminal device may not transmit the discovery response message, which helps to reduce the overhead of transmitting the discovery response message.

In some implementations, the discovery response message may include information indicating that the second terminal device is capable of serving as the anchor terminal device. The information may be, for example, identification information (flag).

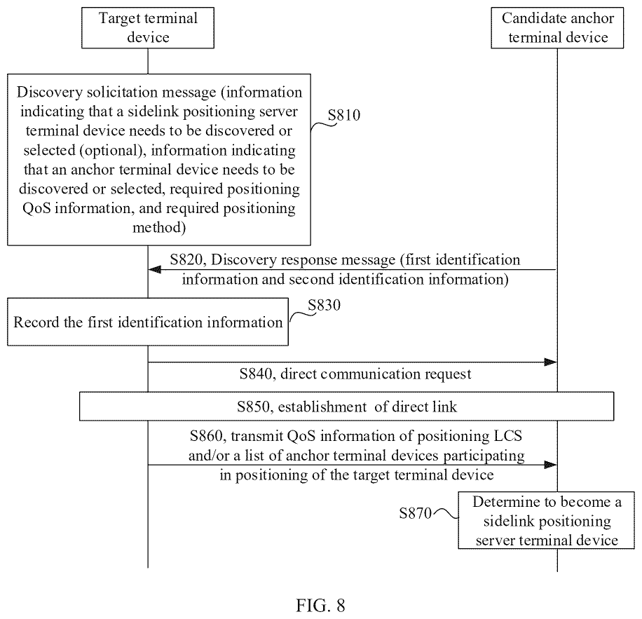

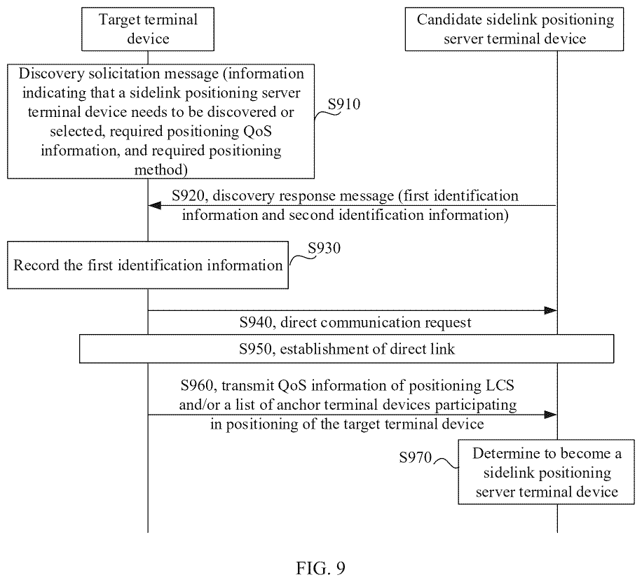

With reference to FIG. 8 and FIG. 9, two more examples of the second embodiment are given below by taking the discovery procedure of the anchor terminal device and the sidelink positioning server terminal device as examples.

The example illustrated in FIG. 8 describes the discovery procedure of the anchor terminal device. In the example of FIG. 8, the first terminal device mentioned above is the target terminal device, and the second terminal device mentioned above is the candidate anchor terminal device.

Referring to FIG. 8, in an operation S810, the target terminal device transmits the discovery solicitation message. The discovery solicitation message may include: information indicating that the sidelink positioning server terminal device needs to be discovered or selected (optional), information indicating that an anchor terminal device needs to be discovered or selected, required positioning QoS information, and required positioning method.

In an operation S820, the candidate anchor terminal device transmits a discovery response message to the target terminal device. The discovery response message may include first identification information (corresponding to the third information mentioned above) and second identification information. The first identification information may be used to indicate that the candidate anchor terminal device supports the positioning QoS information required by the target terminal device and/or a positioning method required by the target terminal device, or that the candidate anchor terminal device is capable of serving as the sidelink positioning server terminal device. The second identification information may be used to indicate that the candidate anchor terminal device is capable of serving as the anchor terminal device.

In an operation S830, the target terminal device records the first identification information.

In an operation S840, the target terminal device transmits a direct communication request to the candidate anchor terminal device. The direct communication request may be used to request establishment of the direct link (or PC5 link) with the candidate anchor terminal device.

In an operation S850, a direct link is established between the target terminal device and the candidate anchor terminal device.

In an operation S860, the target terminal device uses the candidate anchor terminal device as the sidelink positioning server terminal device, and transmits the QoS information of the positioning LCS and/or the list of anchor terminal devices participating in the positioning of the target terminal device to the candidate anchor terminal device.

In an operation S870, the candidate anchor terminal device is determined to become the sidelink positioning server terminal device.

The example illustrated in FIG. 9 describes the discovery procedure of the sidelink positioning server terminal device. In the example of FIG. 9, the first terminal device mentioned above is the target terminal device, and the second terminal device mentioned above is the candidate sidelink positioning server terminal device.

Referring to FIG. 9, in an operation S910, the target terminal device transmits the discovery solicitation message. The discovery solicitation message may include: information indicating that the sidelink positioning server terminal device needs to be discovered or selected; required positioning QoS information; and the required positioning method.

In an operation S920, the candidate sidelink positioning server terminal device transmits a discovery response message to the target terminal device. The discovery response message indicates that the candidate sidelink positioning server terminal device is capable of serving as the sidelink positioning server terminal device.

In an operation S930, the target terminal device records the candidate sidelink positioning server terminal device that is capable of serving as the sidelink positioning server terminal device.

In an operation S940, the target terminal device transmits a direct communication request to the candidate sidelink positioning server terminal device. The direct communication request may be used to request establishment of the direct link (or PC5 link) with the candidate sidelink positioning server terminal device.

In an operation S950, a direct link is established between the target terminal device and the candidate sidelink positioning server terminal device.

In an operation S960, the target terminal device uses the candidate sidelink positioning server terminal device as the sidelink positioning server terminal device, and transmits the QoS information of the positioning LCS and/or the list of anchor terminal devices participating in the positioning of the target terminal device to the candidate sidelink positioning server terminal device.

In an operation S970, the candidate sidelink positioning server terminal device is determined to become the sidelink positioning server terminal device.

### The Third Embodiment: The First Discovery Message is the Discovery Response Message

In the third embodiment, the first terminal device may be the candidate anchor terminal device, and the second terminal device may be the target terminal device. The discovery procedure between the first terminal device and the second terminal device may be the discovery procedure based on model B.

In some implementations, the discovery response message may be used to discover the anchor terminal device.

In some implementations, the discovery response message may be used to discover the sidelink positioning server terminal device.

In some implementations, the first information may be used to indicate positioning QoS information supported by the first terminal device.

In some implementations, the first information may be used to indicate part or all of the positioning QoS information supported by the first terminal device.

In some implementations, the first information may be used to indicate the most affordable supported positioning QoS information of the first terminal device.

In some implementations, positioning QoS information may include or be replaced by the positioning QoS requirement.

In some implementations, the first information may be used to indicate the positioning method supported by the first terminal device.

In some implementations, before the first terminal device transmits the first discovery message, the first terminal device receives the discovery solicitation message transmitted from the second terminal device. The discovery solicitation message may include fourth information, and the fourth information may be used to indicate that the sidelink positioning server terminal device needs to be discovered or selected.

In some implementations, the discovery solicitation message may include information indicating that the anchor terminal device needs to be discovered or selected.

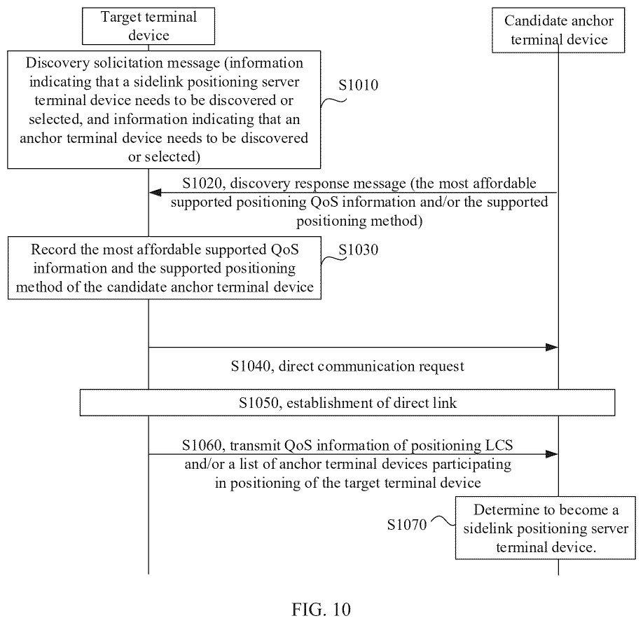

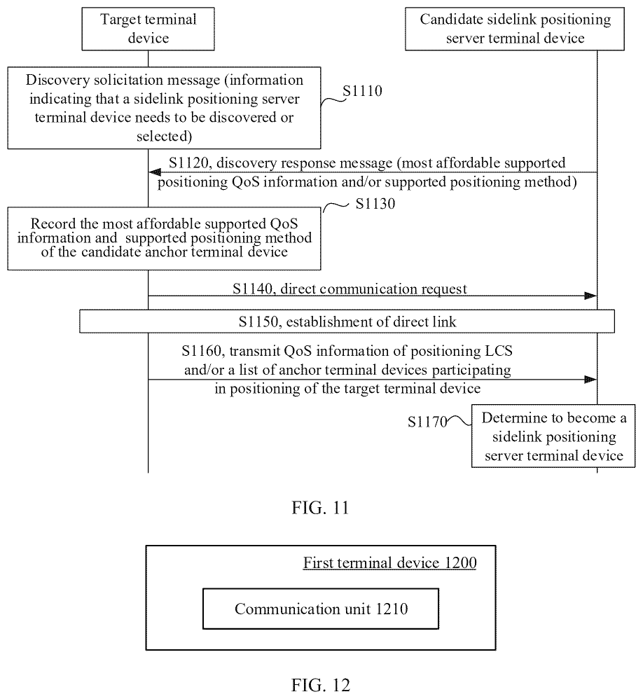

With reference to FIG. 10 and FIG. 11, two more examples of the third embodiment are given below by taking the discovery procedure of the anchor terminal device and the sidelink positioning server terminal device as examples.

The example illustrated in FIG. 10 describes the discovery procedure of the anchor terminal device. In the example of FIG. 10, the first terminal device mentioned above is the candidate anchor terminal device, and the second terminal device mentioned above is a target terminal device.

Referring to FIG. 10, in an operation S1010, the target terminal device transmits the discovery solicitation message. The discovery solicitation message may include: information indicating that a sidelink positioning server terminal device needs to be discovered or selected, and information indicating that an anchor terminal device needs to be discovered or selected.

In an operation S1020, the candidate anchor terminal device transmits the discovery response message to the target terminal device. The discovery response message includes the most affordable supported positioning QoS information of the candidate anchor terminal device and/or the positioning method supported by the candidate anchor terminal device.

In an operation S1030, the target terminal device records the most affordable supported QoS information of the candidate anchor terminal device and the positioning method supported by the candidate anchor terminal device.

In an operation S1040, the target terminal device transmits the direct communication request to the candidate anchor terminal device. The direct communication request may be used to request establishment of a direct link (or PC5 link) with a candidate anchor terminal device.

In an operation S1050, the direct link is established between the target terminal device and the candidate anchor terminal device.

In an operation S1060, the target terminal device uses the candidate anchor terminal device as the sidelink positioning server terminal device, and transmits the QoS information of the positioning LCS and/or the list of anchor terminal devices participating in the positioning of the target terminal device to the candidate anchor terminal device.

In an operation S1070, the candidate anchor terminal device is determined to become the sidelink positioning server terminal device.

The example illustrated in FIG. 11 describes the discovery procedure of the sidelink positioning server terminal device. In the example of FIG. 11, the first terminal device mentioned above is a candidate sidelink positioning server terminal device, and the second terminal device mentioned above is a target terminal device.

Referring to FIG. 11, in an operation S1110, the target terminal device transmits the discovery solicitation message. The discovery solicitation message may include information indicating that the sidelink positioning server terminal device needs to be discovered or selected.

In an operation S1120, the candidate sidelink positioning server terminal device transmits the discovery response message to the target terminal device. The discovery response message includes the most affordable supported positioning QoS information of the candidate sidelink positioning server terminal device and/or the positioning method supported by the candidate sidelink positioning server terminal device.

In an operation S1130, the target terminal device records the most affordable supported QoS information of the candidate sidelink positioning server terminal device and the positioning method supported by the candidate sidelink positioning server terminal device.

In an operation S1140, the target terminal device transmits the direct communication request to the candidate sidelink positioning server terminal device. The direct communication request may be used to request establishment of the direct link (or PC5 link) with the candidate sidelink positioning server terminal device.

In an operation S1150, a direct link is established between the target terminal device and the candidate sidelink positioning server terminal device.

In an operation S1160, the target terminal device uses the candidate sidelink positioning server terminal device as the sidelink positioning server terminal device, and transmits the QoS information of the positioning LCS and/or the list of anchor terminal devices participating in the positioning of the target terminal device to the candidate sidelink positioning server terminal device.

In an operation S1170, the candidate sidelink positioning server terminal device is determined to become the sidelink positioning server terminal device.

In some implementations, in a case where the first discovery message carries the first information associated with the positioning QoS, the positioning QoS associated with the first information may include one or more positioning QoS supported by the first terminal device. For example, taking the positioning QoS index 1 and the positioning QoS index 2 shown in Table 1 as an example, the first information may be associated with the positioning QoS corresponding to the positioning QoS index 1 and the positioning QoS corresponding to the positioning QoS index 2. Of course, the first information may be associated only with the positioning QoS corresponding to the positioning QoS index 1.

In some embodiments, the first discovery message may be the discovery solicitation message. That is to say, the first information may be carried in the discovery solicitation message.

In some implementations, in a case where the first discovery message carries the first information associated with the positioning QoS, the positioning QoS associated with the first information may include a certain positioning QoS requested by the first terminal device. For example, taking the positioning QoS index 1 and the positioning QoS index 2 shown in Table 1 as an example, the first information may be associated only with the positioning QoS corresponding to the positioning QoS index 1.

In some scenarios, after the first terminal device has transmitted the first information through the discovery solicitation message, it may fail to discover or select a suitable sidelink positioning server terminal device. At this time, in order to increase the possibility of positioning the target terminal device (for example, the first terminal device), the first terminal device may lower the positioning QoS parameter and retransmit the discovery solicitation message.

It should be noted that the embodiment of the present disclosure does not limit the deadline conditions for retransmitting the discovery solicitation message. For example, after the message has been retransmitted a predefined number of times, in a case where the suitable sidelink positioning server terminal device still may not be discovered or selected, the terminal device may stop transmitting the discovery solicitation message. For another example, after the message has been retransmitted for a preset time period, in a case where the suitable sidelink positioning server terminal device still may not be discovered or selected, the terminal device may stop transmitting the discovery solicitation message. For another example, the first terminal device keeps retransmitting the discovery solicitation message until it discovers or selects the suitable sidelink positioning server terminal device, and then it stops transmitting the discovery solicitation message.

In some implementations, the positioning QoS includes a first association relationship between the positioning QoS index and the positioning QoS parameter. The embodiment of the present disclosure does not specifically limit the type of the positioning QoS parameter. For example, the positioning QoS parameter may include one or more of: horizontal accuracy; vertical accuracy; or response delay.

The above-mentioned first association relationship may be presented in a table or other forms. Table 1 shows a possible implementation of the first association relationship. As can be seen from Table 1, in a case where the QoS index is 1, the associated QoS parameter includes horizontal accuracy of 5 m; vertical accuracy of 5 m and response time of 0.5 second. In a case where the QoS index is 2, the associated QoS parameter includes horizontal accuracy of 1 m, vertical accuracy of 1 m, and response time of 1 second.

TABLE 1

| Positioning | Horizontal | Vertical | |
|---|---|---|---|
| QoS index | accuracy | accuracy | Response time |
| 1 | 5 m | 5 m | 0.5 seconds |
| 2 | 1 m | 1 m | 1 second |

In some implementations, the positioning QoS index may have a second association relationship with the positioning method. As mentioned above, the positioning QoS index has a first association relationship with the positioning QoS parameter. Therefore, in this embodiment, the positioning method and the positioning QoS parameter are also associated together through the positioning QoS index. Furthermore, in some embodiments, the positioning method associated with the positioning QoS index may satisfy the QoS parameter associated with the positioning QoS index.

As shown in Table 2, in a case where the QoS index is 1, the associated QoS parameter includes horizontal accuracy of 5 m, vertical accuracy of 5 m, and response time of 0.5 seconds. In addition, the positioning method associated with the QoS index 1 is the angle of arrival based positioning method, that is, the positioning accuracy of the angle of arrival based positioning method may meet the QoS parameter associated with the QoS index 1. In a case where the QoS index is 2, the associated QoS parameter includes horizontal accuracy of 1 m, vertical accuracy of 1 m, and response time of 1 second. In addition, the positioning method associated with the QoS index 2 is the round-trip time based positioning method, that is, the positioning accuracy of the round-trip time based positioning method may meet the QoS parameter associated with the QoS index 2.

TABLE 2

| Positioning | Horizontal | Vertical | Response | |
|---|---|---|---|---|
| QoS index | accuracy | accuracy | time | Positioning method |
| 1 | 5 m | 5 m | 0.5 | Angle-of-arrival based |
| | | | seconds | positioning method |
| 2 | 1 m | 1 m | 1 | Round-trip time based |
| | | | second | positioning method |

It should be noted that the first association relationship and the second association relationship may be represented by a table (such as Table 2). Alternatively, in other embodiments, the first association relationship and the second association relationship may also be represented by multiple tables, and the multiple tables may have the same positioning QoS index, so that the multiple tables are associated together.

In some implementations, the positioning QoS index may be carried in the first discovery message, thereby simultaneously indicating the QoS parameter associated with the QoS index and the positioning method, which helps reduce the overhead required to transmit the positioning method and the QoS parameter.

As mentioned above, the above QoS parameter may include the LCS QoS class. The LCS QoS class may be used to indicate the degree to which the LCS service complies with the QoS parameter. In some implementations, the LCS QoS class may include one of the following classes: a best effort class, a multiple QoS class, or an assured class.

For ease of understanding, the following introduces the first association relationship and the second association relationship of another embodiment of the present disclosure in conjunction with Table 3. As shown in Table 3, in a case where the QoS index is 1, the associated QoS parameter include horizontal accuracy of 5 m, vertical accuracy of 5 m, and response time of 0.5 seconds. In addition, the positioning method associated with QoS index 1 is the angle-of-arrival based positioning method, that is, the positioning accuracy of the angle-of-arrival based positioning method may meet the QoS parameter associated with QoS index 1. In a case where the QoS index is 2, the associated QoS parameter includes horizontal accuracy of 1 m, vertical accuracy of 1 m, and response time of 1 second. In addition, the positioning method associated with the QoS index 2 is the round-trip time based positioning method, that is, the positioning accuracy of the round-trip time based positioning method may meet the QoS parameter associated with the QoS index 2. In addition, the QoS parameter associated with the positioning QoS index may also include an LCS QoS class, which is used to indicate the degree to which the LCS service complies with the QoS parameter.

TABLE 3

| Positioning | Horizontal | Vertical | Response | Positioning |
|---|---|---|---|---|
| QoS index | accuracy | accuracy | time | method |
| 1 | 5 m | 5 m | 0.5 seconds | Angle-of-arrival |
| | | | | based positioning |
| | | | | method |
| 2 | 1 m | 1 m | 1 second | Round-trip time |
| | | | | based positioning |
| | | | | method |
| Qos | M | LCS QoS class | | |
| parameter | | | | |

In some implementations, the positioning QoS associated with the first information may be used to discover or select the sidelink positioning server terminal device. In other scenarios, the first terminal device may also transmit a positioning QoS used to discover or select the anchor terminal device. For ease of distinction, the positioning QoS used to discover or select the sidelink positioning server terminal device is called “positioning QoS1”, and the positioning QoS used to discover or select the anchor terminal device is called “positioning QoS2”. In some implementations, the positioning QoS1 described above may be different from the positioning QoS2. For example, the positioning QoS1 may include a positioning method, so as to discover or select a sidelink positioning server terminal device that supports the positioning algorithm. Accordingly, the positioning QoS2 may not include a positioning method, and in this case, the anchor terminal device may not be required to support the positioning algorithm. Of course, in the embodiment of the present disclosure, the above-mentioned positioning QoS1 may be the same as the positioning QoS2.

In some embodiments, the first terminal device may transmit the fifth information, and correspondingly, the second terminal device receives the fifth information. The fifth information is used for authentication of ranging/sidelink positioning, and the fifth information includes positioning QoS and/or positioning method. By carrying the fifth information, the authentication result can be made more accurate. The transmission procedure of the fifth information and the transmission procedure of the first information to the fourth information mentioned above may be independent of each other or may be combined with each other. For example, in some implementations, the first terminal device and the second terminal device may only exchange the first information to the fourth information mentioned above, but not exchange the fifth information. For another example, in some implementations, the first terminal device and the second terminal device may only exchange the fifth information, but not exchange the first information to the fourth information mentioned above. For example, in some implementations, the first terminal device and the second terminal device can exchange the fifth information as well as the first information to the fourth information mentioned above.

In the embodiment of the present disclosure, the specific type of the fifth information is not limited. For example, the fifth information may be a non-access stratum (NAS) message.

The above describes in detail the method embodiment of the present disclosure in conjunction with FIG. 1 to FIG. 11, and the following describes in detail the apparatus embodiment of the present disclosure in conjunction with FIG. 12 to FIG. 14. It should be understood that the description of the method embodiment corresponds to the description of the apparatus embodiment, and therefore, for parts that are not described in detail, reference may be made to the previous method embodiment.

FIG. 12 is a schematic diagram of a terminal device according to an embodiment of the present disclosure. The terminal device 1200 illustrated in FIG. 12 is the first terminal device. The terminal device 1200 includes: a communication unit 1210.

The communication unit 1210 is configured to transmit a first discovery message, where the first discovery message includes first information, where the first information is associated with one or more of: positioning service quality (QoS), or positioning method.

In one possible implementation, the first discovery message is a discovery announcement message, and the first information is used to indicate positioning QoS information supported by the first terminal device and/or a positioning method supported by the first terminal device.

In one possible implementation, the first discovery message is a discovery solicitation message, and the first information is used to indicate positioning QoS information required by the first terminal device and/or a positioning method required by the first terminal device.

In one possible implementation, the discovery solicitation message further includes second information, where the second information is used to indicate that a sidelink positioning server terminal device needs to be discovered or selected.

In one possible implementation, the communication unit is further configured to: receive a response message transmitted from a second terminal device, where the discovery response message includes third information, and the third information is used to indicate one or more of: the second terminal device supporting the positioning QoS information required by the first terminal device and/or the positioning method required by the first terminal device; or the second terminal device being capable of serving as a sidelink positioning server terminal device.

In one possible implementation, the third information includes a first bit, and in a case where a value of the first bit is a first value, the first bit is used to indicate that the second terminal device is capable of serving as the sidelink positioning server terminal device; and/or in a case where the value of the first bit is a second value, the first bit is used to indicate that the second terminal device is incapable of serving as the sidelink positioning server terminal device, where the first value is different from the second value.

In one possible implementation, the first discovery message is a discovery response message, and the first information is used to indicate positioning QoS information supported by the first terminal device and/or a positioning method supported by the first terminal device.

In one possible implementation, the communication unit is further configured to: before the first terminal device transmits the first discovery message, receive a discovery solicitation message transmitted from a second terminal device, where the discovery solicitation message includes fourth information, and the fourth information is used to indicate that a sidelink positioning server terminal device needs to be discovered or selected.

In one possible implementation, the first discovery message is a discovery message transmitted during a discovery or selection procedure of an anchor terminal device.

In one possible implementation, the first discovery message is a discovery message transmitted during a discovery or selection procedure of a sidelink positioning server terminal device.

In one possible implementation, the positioning QoS includes a positioning QoS parameter, and the positioning QoS parameter includes one or more of: vertical accuracy; horizontal accuracy; response delay; location service (LCS) QoS class; and/or the positioning QoS includes: a first association relationship between a positioning QoS index and the positioning QoS parameter.

In one possible implementation, the positioning QoS index has a second association relationship with the positioning method.

In one possible implementation, the communication unit is further configured to: transmit fifth information, where the fifth information is used for authentication of ranging/sidelink positioning, and the fifth information includes the positioning QoS and/or the positioning method.

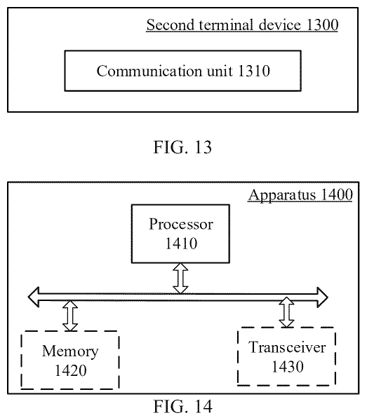

FIG. 13 is a schematic diagram of a terminal device according to an embodiment of the present disclosure. The terminal device 1300 illustrated in FIG. 13 may be the second terminal device, and the terminal device 1300 includes: a communication unit 1310.

The communication unit 1310 is configured to receive a first discovery message, where the first discovery message includes first information, where the first information is associated with one or more of: positioning service quality (QoS); or a positioning method.

In one possible implementation, the first discovery message is a discovery announcement message, and the first information is used to indicate positioning QoS information supported by a first terminal device and/or a positioning method supported by the first terminal device.

In one possible implementation, the first discovery message is a discovery solicitation message, and the first information is used to indicate positioning QoS information required by the first terminal device and/or a positioning method required by the first terminal device.

In one possible implementation, the discovery solicitation message further includes second information, and the second information is used to indicate that a sidelink positioning server terminal device needs to be discovered or selected.

In one possible implementation, the communication unit is further configured to: transmit a discovery response message to the first terminal device, where the discovery response message includes third information, and the third information is used to indicate one or more of: the second terminal device supporting the positioning QoS information required by the first terminal device and/or the positioning method required by the first terminal device, or the second terminal device being capable of serving as a sidelink positioning server terminal device.

In one possible implementation, the third information includes a first bit, and in a case where a value of the first bit is a first value, the first bit is used to indicate that the second terminal device is capable of serving as the sidelink positioning server terminal device; and/or in a case where the value of the first bit is a second value, the first bit is used to indicate that the second terminal device is incapable of serving as the sidelink positioning server terminal device, where the first value is different from the second value.

In one possible implementation, the first discovery message is a discovery response message, and the first information is used to indicate positioning QoS information supported by the first terminal device and/or a positioning method supported by the first terminal device.

In one possible implementation, the communication unit is further configured to: before the second terminal device receives the first discovery message, transmit a discovery solicitation message to the first terminal device, where the discovery solicitation message includes fourth information, and the fourth information is used to indicate that a sidelink positioning server terminal device needs to be discovered or selected.

In one possible implementation, the first discovery message is a discovery message transmitted during a discovery or selection procedure of an anchor terminal device.

In one possible implementation, the first discovery message is a discovery message transmitted during a discovery or selection procedure of a sidelink positioning server terminal device.

In one possible implementation, the positioning QoS includes a positioning QoS parameter, and the positioning QoS parameter includes one or more of: vertical accuracy; horizontal accuracy; response delay; location service (LCS) QoS class; and/or the positioning QoS includes: a first association relationship between a positioning QoS index and the positioning QoS parameter.

In one possible implementation, the positioning QoS index has a second association relationship with the positioning method.

In one possible implementation, the communication unit is further used to: receive fifth information, where the fifth information is used for authentication of ranging/sidelink positioning, and the fifth information includes the positioning QoS and/or the positioning method.

In an optional embodiment, the communication unit 1210 may be a transceiver 1430. The terminal device 1200 may further include a processor 1410 and a memory 1420, as illustrated in FIG. 14.

In an optional embodiment, the communication unit 1310 may be a transceiver 1430. The terminal device 1300 may further include a processor 1410 and a memory 1420, as illustrated in FIG. 14.

FIG. 14 is a schematic structural diagram of a communication device according to an embodiment of the present disclosure. The dashed lines in FIG. 14 indicate that the unit or module is optional. The apparatus 1400 may be used to implement the method described in the above method embodiments. The apparatus 1400 may be a chip, a terminal device, or a network device.

The apparatus 1400 may include one or more processors 1410. The processor 1410 may support the apparatus 1400 to implement the method described in the above method embodiment. The processor 1410 may be a general-purpose processor or a special-purpose processor. For example, the processor may be a central processing unit (CPU). Alternatively, the processor may be other general-purpose processors, digital signal processors (DSP), application specific integrated circuits (ASIC), field programmable gate arrays (FPGA) or other programmable logic devices, discrete gate or transistor logic devices, discrete hardware components, etc. The general purpose processor may be a microprocessor, or the processor may be any conventional processor or the like.

The apparatus 1400 may further include one or more memories 1420. The memory 1420 stores a program that, when executed by the processor 1410, enables the processor 1410 to perform the method described in the above method embodiment. The memory 1420 may be independent of the processor 1410 or may be integrated into the processor 1410.

The apparatus 1400 may further include a transceiver 1430. The processor 1410 may communicate with other devices or chips through the transceiver 1430. For example, the processor 1410 may transmit and receive data with other devices or chips through the transceiver 1430.

The embodiments of the present disclosure further provide a non-transitory computer-readable storage medium for storing a program. The non-transitory computer-readable storage medium may be applied to the terminal device of the embodiments of the present disclosure, and the program enables a computer to perform the method implemented by the terminal device in various embodiments of the present disclosure.

The embodiments of the present disclosure further provide a computer program product. The computer program product includes a program. The computer program product may be applied to the terminal device of the embodiments of the present disclosure, and the program enables the computer to perform the methods implemented by the terminal device in various embodiments of the present disclosure.

The embodiments of the present disclosure further provide a computer program. The computer program may be applied to the terminal device of the embodiments of the present disclosure, and the computer program enables the computer to perform the method implemented by the terminal device in various embodiments of the present disclosure.

In the embodiments of the present disclosure, any of the information mentioned above may be carried by one or more of: a unicast message, a multicast message or a broadcast message.

The above-mentioned unicast message can be understood as one-to-one transmission information, that is, a message transmitted from one transmitting end to one receiving end. At this time, the information source transmits the unicast message through a unicast channel. Only the terminal device or the network device that is allocated with the corresponding unicast resource may attempt to receive the unicast messages. The unicast message may also be called dedicated signaling.

The multicast message may be understood as one-to-many transmission information, that is, a message transmitted from one transmitting end to multiple receiving ends. At this time, the information source transmits the multicast message through a multicast channel. The terminal device or network device that serves as a group member within a coverage range of the multicast signal may attempt to receive the multicast message. In a case where the terminal device or network device joins a group, the terminal device or network device obtains multicast channel related resources.

The above broadcast message can be understood as one-to-arbitrary transmission information, that is, a message transmitted from a transmitting end to an arbitrary receiving end. At this time, the information source transmits the broadcast message through a broadcast channel, and any terminal device or network device within a coverage range of the broadcast signal may attempt to receive the broadcast message.

It is to be understood that the terms “system” and “network” may be used interchangeably in the present disclosure. In addition, terms used in the present disclosure are only used to explain embodiments of the present disclosure and are not intended to limit the present disclosure. The terms “first”, “second”, “third”, “fourth” or the like in the specification, claims and the drawings are used to distinguish different objects and are not used to describe a specified sequence. In addition, the terms “include”, “comprise” and “have” and any variations thereof are intended to cover non-exclusive inclusion.

In the embodiments of the present disclosure, “indicate” mentioned in the embodiments of the present disclosure may mean a direct indication or an indirect indication, or represent that there is an association relationship. For example, A indicates B, which may mean that A directly indicates B, for example, B may be obtained through A; or it may mean that A indirectly indicates B, for example, A indicates C, and B may be obtained through C; or it may mean that there is an association relationship between A and B.

In the embodiments of the present disclosure, the term “correspond” may mean that there is a direct correspondence or indirect correspondence between the two, or it may mean that there is an associated relationship between the two, or it may mean a relationship of indicating and being indicated, configuring and being configured, or the like.

In the embodiments of the present disclosure, the “comprising/including” may refer to direct including or indirect including. Optionally, the term “comprising/including” mentioned in the embodiments of the present disclosure may be replaced with “indicating” or “for determining”. For example, A including B may be replaced by A indicating B, or A being used to determine B.

In the embodiment of the present disclosure, “predefined” or “preconfigured” may be achieved by pre-storing corresponding codes, forms or other means used for indicating relevant information in devices (e.g., including a terminal device and network device), and the present disclosure is not limited to the specific implementation thereof. For example, predefined may refer to what is defined in a protocol.

In the embodiments of the present disclosure, the “protocol” may refer to a standard protocol in the field of communication, and may include, for example, LTE protocol, NR protocol, or related protocols applied in future communication systems, which are not limited in the present disclosure.

In the embodiments of the present disclosure, the term “and/or” is only an association relationship to describe associated objects, meaning that there may be three relationships between associated objects, for example, “A and/or B” may represent: A exists alone, both A and B exist, and B exists alone. In addition, a character “/” herein generally means that related objects before and after this character are in an “or” relationship.

In various embodiments of the present disclosure, the magnitude of the serial numbers of above processes does not mean the order of execution. The order of execution of each process should be determined by its function and internal logic, and should not constitute any limitation on the implementation process of the embodiments of the present disclosure.

In the several embodiments provided in the present disclosure, it is to be understood that the disclosed systems, devices and methods may be implemented in other ways. For example, the apparatus embodiments described above are merely illustrative. For example, the division of the units is merely a logical function division. There may be other division ways in the actual implementation. For example, multiple units or components may be combined or integrated into another system, or some features may be ignored or not implemented. Another point is that the mutual coupling or direct coupling or communication connection illustrated or discussed may be indirect coupling or communication connection through some interfaces, apparatuses or units, and may be electrical, mechanical or other forms.

The units described as separation components may or may not be physically separated, and the components displayed as a unit may be or may not be physical units, that is, they may be located at one place, or they may be distributed to multiple network units. Some or all of the units may be selected according to actual requirements to achieve the purpose of the schemes of the embodiments.

In addition, various functional units in various embodiments of the present disclosure may be integrated into one processing unit, various units may exist physically alone, or two or more units may be integrated into one unit.

In the above embodiments, all or part of them may be implemented by software, hardware, firmware or any combinations thereof. When implemented by the software, all or part of them may be implemented in the form of a computer program product. The computer program product includes one or more computer instructions. When the computer program instructions are loaded and executed on a computer, the processes or functions described in the embodiments of the present disclosure are generated in whole or in part. The computer may be a general-purpose computer, a special-purpose computer, a computer network, or other programmable devices. The computer instructions may be stored in a non-transitory computer-readable storage medium, or transmitted from one non-transitory computer-readable storage medium to another non-transitory computer-readable storage medium. For example, the computer instructions may be transmitted from a website, a computer, a server or a data center to another website, computer, server, or data center via wired (e.g., a coaxial cable, optical fiber, digital subscriber line (DSL)) or wireless (e.g., infrared, wireless, microwave) means. The non-transitory computer-readable storage medium may be any available medium that may be read by the computer or a data storage device such as a server or a data center that includes one or more available media. The available media may be magnetic media (e.g., a floppy disk, a hard disk or a magnetic tape), optical media (e.g., a digital video disc (DVD)), or semiconductor media (e.g., a solid state disk (SSD)).

The foregoing descriptions are merely some implementations of the present disclosure, but the protection scope of the present disclosure is not limited thereto. Variations or replacements that any person skilled in the art could readily conceive of within the technical scope disclosed in the present disclosure shall fall within the protection scope of the present disclosure. Therefore, the protection scope of the present disclosure shall be subject to the protection scope of the claims.

What is claimed is:

1. A sidelink communication method, comprising:
transmitting, by a first terminal device, a first discovery message, wherein the first discovery message comprises first information,
wherein the first information is associated with one or more of:
positioning quality of service (QoS), or
a positioning method.

2. The method according to claim 1, wherein the first discovery message is a discovery announcement message, and the first information is used to indicate positioning QoS information supported by the first terminal device and/or a positioning method supported by the first terminal device.

3. The method according to claim 1, wherein the first discovery message is a discovery solicitation message, and the first information is used to indicate positioning QoS information required by the first terminal device and/or a positioning method required by the first terminal device.

4. The method according to claim 3, wherein the discovery solicitation message further comprises second information, and the second information is used to indicate that a sidelink positioning server terminal device needs to be discovered or selected.

5. The method according to claim 3, further comprising:
receiving, by the first terminal device, a discovery response message transmitted from a second terminal device, wherein the discovery response message comprises third information, and the third information is used to indicate one or more of:
the second terminal device supporting the positioning QoS information required by the first terminal device and/or the positioning method required by the first terminal device, or
the second terminal device being capable of serving as a sidelink positioning server terminal device;
wherein the third information comprises a first bit, and in a case where a value of the first bit is a first value, the first bit is used to indicate that the second terminal device is capable of serving as the sidelink positioning server terminal device; and/or
in a case where the value of the first bit is a second value, the first bit is used to indicate that the second terminal device is incapable of serving as the sidelink positioning server terminal device, the first value being different from the second value.

6. The method according to claim 1, wherein the first discovery message is a discovery response message, and the first information is used to indicate positioning QoS information supported by the first terminal device and/or a positioning method supported by the first terminal device;
wherein before the first terminal device transmits the first discovery message, the method further comprises:
receiving, by the first terminal device, a discovery solicitation message transmitted from a second terminal device, wherein the discovery solicitation message comprises fourth information, and the fourth information is used to indicate that a sidelink positioning server terminal device needs to be discovered or selected.

7. The method according to claim 1, wherein the first discovery message is a discovery message transmitted during a discovery or selection procedure of an anchor terminal device; or
the first discovery message is a discovery message transmitted during a discovery or selection procedure of a sidelink positioning server terminal device.

8. The method according to claim 1, wherein the positioning QoS comprises a positioning QoS parameter, and the positioning QoS parameter comprises one or more of: vertical accuracy, horizontal accuracy, response delay, or location service (LCS) QoS class; and/or
the positioning QoS comprises: a first association relationship between a positioning QoS index and the positioning QoS parameter;
wherein the positioning QoS index has a second association relationship with the positioning method.

9. The method according to claim 1, further comprising:
transmitting, by the first terminal device, fifth information, wherein the fifth information is used for authentication of ranging/sidelink positioning, and the fifth information comprises the positioning QoS and/or the positioning method.

10. A sidelink communication method, comprising:
receiving, by a second terminal device, a first discovery message, wherein the first discovery message comprises first information,
wherein the first information is associated with one or more of:
positioning quality of service (QoS), or
a positioning method.

11. The method according to claim 10, wherein the first discovery message is a discovery announcement message, and the first information is used to indicate positioning QoS information supported by a first terminal device and/or a positioning method supported by the first terminal device.

12. The method according to claim 10, wherein the first discovery message is a discovery solicitation message, and the first information is used to indicate positioning QoS information required by a first terminal device and/or a positioning method required by the first terminal device.

13. The method according to claim 12, wherein the discovery solicitation message further comprises second information, and the second information is used to indicate that a sidelink positioning server terminal device needs to be discovered or selected.

14. The method according to claim 12, further comprising:
transmitting, by the second terminal device, a discovery response message to the first terminal device, wherein the discovery response message comprises third information, and the third information is used to indicate one or more of:
the second terminal device supporting the positioning QoS information required by the first terminal device and/or the positioning method required by the first terminal device, or
the second terminal device being capable of serving as a sidelink positioning server terminal device;
wherein the third information comprises a first bit, and in a case where a value of the first bit is a first value, the first bit is used to indicate that the second terminal device is capable of serving as the sidelink positioning server terminal device; and/or
in a case where the value of the first bit is a second value, the first bit is used to indicate that the second terminal device is incapable of serving as the sidelink positioning server terminal device, the first value being different from the second value.

15. The method according to claim 10, wherein the first discovery message is a discovery response message, and the first information is used to indicate positioning QoS information supported by a first terminal device and/or a positioning method supported by the first terminal device;
wherein before the second terminal device receives the first discovery message, the method further comprises:
transmitting, by the second terminal device, a discovery solicitation message to the first terminal device, wherein the discovery solicitation message comprises fourth information, and the fourth information is used to indicate that a sidelink positioning server terminal device needs to be discovered or selected.

16. The method according to claim 10, wherein the first discovery message is a discovery message transmitted during a discovery or selection procedure of an anchor terminal device; or
the first discovery message is a discovery message transmitted during a discovery or selection procedure of a sidelink positioning server terminal device.

17. The method according to claim 10, wherein the positioning QoS comprises a positioning QoS parameter, and the positioning QoS parameter comprises one or more of: vertical accuracy, horizontal accuracy; response delay, or location service (LCS) QoS class; and/or
the positioning QoS comprises: a first association relationship between a positioning QoS index and the positioning QoS parameter;
wherein the positioning QoS index has a second association relationship with the positioning method.

18. The method according to claim 10, further comprising:
receiving, by the second terminal device, fifth information, wherein the fifth information is used for authentication of ranging/sidelink positioning, and the fifth information comprises the positioning QoS and/or the positioning method.

19. A terminal device, wherein the terminal device is a first terminal device comprising: a transceiver, a memory and a processor, wherein the memory is configured to store a program, and the processor is configured to execute the program from the memory and control the transceiver to receive or transmit signals, to cause the terminal device to perform:
transmitting a first discovery message, wherein the first discovery message comprises first information,
wherein the first information is associated with one or more of:
positioning quality of service (QoS), or
a positioning method.

20. The terminal device according to claim 19, wherein the first discovery message is a discovery announcement message, and the first information is used to indicate positioning QoS information supported by the first terminal device and/or a positioning method supported by the first terminal device.
